(19) United States
(12) Patent Application Publication
(10) Pub. No.: US 2017/0302617 A1
(43) Pub. Date: Oct. 19, 2017

(54) Method and Registration Node for Managing Application Resource in Machine to Machine (M2M)

(71) Applicant: ZTE Corporation, Shenzhen (CN)

(72) Inventor: Hao WU, Shenzhen (CN)

(21) Appl. No.: 15/512,762

(22) PCT Filed: Apr. 9, 2015
(86) PCT No.: PCT/CN2015/076189

§ 371 Date: Mar. 20, 2017

(30) Foreign Application Priority Data
Sep. 19, 2014 (CN) 201410484261.5

(51) Int. Cl. H04L 29/12; H04W 4/02; H04W 4/00; H04L 29/08; H04W 76/04

(52) U.S. Cl. CPC H04L 61/1535; H04L 67/327; H04W 76/045; H04W 4/005; H04W 4/025; H04L 67/04

(57) ABSTRACT

A method and registration node for managing an application resource in Machine to Machine (M2M) are provided. The method includes that: an Application Entity (AE) or a Common Service Entity (CSE) sends a node resource creation request to a registration CSE of the AE or CSE to request a resource for an application node where the AE is located or an intermediate node where the CSE is located; and the registration CSE creates a node resource for the application node or the intermediate node, and establishes an association relationship between an AE resource which has been created for the AE and the currently created node resource, or establishes an association relationship between a CSE resource which has been created for the CSE and the currently created node resource, an attribute of the AE resource includes the AE identity and an attribute of the CSE resource includes the CSE identity.

### TECHNICAL FIELD

The present disclosure relates to M2M communications, and more particularly to a method and registration node for managing an application resource in M2M.

### BACKGROUND

An M2M communication network consists of M2M nodes and a bearer network. The M2M nodes implement mutual communication through the bearer network. An M2M node at least includes an Application Entity (AE) or a Common Service Entity (CSE). The AE is a logical unit for executing M2M applications. The CSE is a logical unit for managing and serving M2M applications.

FIG. 1 is a structure diagram of an M2M communication network according to a related technology. In the figure, the M2M nodes include an application node including an AE, an intermediate node including a CSE and a basic node including a CSE. The application node is an end execution node, such as an intelligent electric meter, a temperature measurement and control sensor, a fire alarm and an intelligent home appliance. The intermediate node is middleware which connects the end execution nodes to a network-side server, such as a gateway. The basic node is a server at the network side, and an application registered on the basic node may be a management platform of an M2M service provider.

Communication between M2M applications is implemented by interaction between the CSE. In order to achieve the interaction, the AE on the application node is required to initiate registration to the CSE of the intermediate node, and the CSE of the intermediate node is required to initiate registration to the CSE of the basic node. The CSE on the intermediate node is called as a local CSE or registration CSE of the AE on the application node. The CSE on the basic node is called as a local CSE or registration CSE of the CSE on the intermediate node.

In the related technology, when the registration CSE of the AE on the application node and the registration CSE of the CSE on the intermediate node respectively manage an AE resource on the application node and a CSE resource on the intermediate node, the application node bearing the AE resource and the intermediate node bearing the CSE resource are not considered.

In addition, when the application node and the intermediate node are replaced and replacing application node and intermediate node run the same applications as the replaced application node and intermediate node, running data of the applications on the replaced application node and intermediate node is usually expected to be reserved. However, the registration CSE of the AE on the application node may delete locally stored AE resource after learning about the deletion of the application node. Similarly, in the related technology, the registration CSE of the CSE on the intermediate node may delete locally stored CSE resource on the intermediate node after learning about the deletion of the intermediate node. Therefore, after a node replacement operation is executed, the replacing application node and intermediate node are required to initiate registration to the CSEs and create corresponding resources again when being started. As a result, not only may earlier application data be lost, but also a repeated resource creation process may influence working efficiency of M2M.

### SUMMARY

Embodiments of the present disclosure provide a method and registration node for managing an application resource in M2M, so as to solve the technical problem of how to associate an AE resource with a node to which the AE resource belongs and associate a CSE resource with a node to which the CSE resource belongs on registration CSEs.

In order to solve the technical problem, an embodiment of the present disclosure provides a method for managing an application resource, which may include the following steps.

An AE or a CSE sends a node resource creation request to a registration CSE of the AE or CSE to request a resource for an application node where the AE is located or an intermediate node where the CSE is located, the node resource creation request includes an AE identity of the AE or a CSE identity of the CSE, a node identity and a type of the resource to be created.

The registration CSE creates a node resource for the application node or the intermediate node, and establishes an association relationship between an AE resource which has been created for the AE and the currently created node resource, or establishes an association relationship between a CSE resource which has been created for the CSE and the currently created node resource, an attribute of the AE resource includes the AE identity and an attribute of the CSE resource includes the CSE identity.

In an exemplary embodiment, after the AE or the CSE sends the node resource creation request to the registration CSE to request the resource for the application node or the intermediate node, the method may further include the following steps.

When the AE is located on a new application node or the CSE is located on a new intermediate node in case of node replacement, the AE or the CSE sends a node resource deletion request to the registration CSE.

The registration CSE deletes the node resource created for the application node or the intermediate node and the association relationship.

In an exemplary embodiment, in the method, the node resource deletion request includes a node replacement indication, the AE identity or the CSE identity.

The method may further include the following step.

The registration CSE, besides deleting the node resource created for the application node or the intermediate node and the association relationship, further allocates a replacing node identity to the AE or the CSE, and returns the replacing node identity to the AE or the CSE, the replacing node identity corresponds to the AE identity or the CSE identity.

In an exemplary embodiment, the method may further include the following steps.

After the registration CSE returns the replacing node identity to the AE or the CSE, the AE or the CSE sends a node resource creation request to the registration CSE to request a resource for the new application node or the new intermediate node, the node resource creation request includes the replacing node identity, the node identity and the type of the resource to be created.

The registration CSE creates a new node resource for the new application node or the new intermediate node, finds a corresponding AE resource or CSE resource according to the replacing node identity, and establishes an association relationship between the AE resource and the currently created node resource, or establishes an association relationship between the CSE resource and the currently created node resource.

In an exemplary embodiment, the step that the association relationship between the AE resource and the currently created node resource is established may include that: the association relationship between the AE resource of which the attribute includes the AE identity and the currently created node resource is established; and

the step that the association relationship between the CSE resource and the currently created node resource is established may include that: the association relationship between the CSE resource of which the attribute includes the CSE identity and the currently created node resource is established.

In an exemplary embodiment, the step that the association relationship between the AE resource and the currently created node resource is established may include that: a value of a “node connection” attribute of the AE resource is set to be the node identity or an address of the currently created node resource; and

the step that the association relationship between the CSE resource and the currently created node resource is established may include that: a value of a “node connection” attribute of the CSE resource is set to be the node identity or an address of the currently created node resource.

In order to solve the technical problem, an embodiment of the present disclosure further provides a registration node for managing an application resource, which may include: a resource management module and a resource association module.

The resource management module may be arranged to, after receiving a node resource creation request sent by an AE or a CSE, create a node resource for an application node where the AE is located or an intermediate node where the CSE is located. The node resource creation request includes an AE identity of the AE or a CSE identity of the CSE, a node identity and a type of the resource to be created.

The resource association module may be arranged to establish an association relationship between an AE resource which has been created for the AE and the currently created node resource, or establish an association relationship between a CSE resource which has been created for the CSE and the currently created node resource. An attribute of the AE resource includes the AE identity and an attribute of the CSE resource includes the CSE identity.

In an exemplary embodiment, the resource management module may further be arranged to, when receiving a node resource deletion request from the AE or the CSE after receiving the node resource creation request sent by the AE or the CSE, delete the node resource created for the application node or the intermediate node and the association relationship.

In an exemplary embodiment, the node resource deletion request may include a node replacement indication, the AE identity or the CSE identity.

The resource management module may further be arranged to allocate a replacing node identity to the AE or the CSE, and return the replacing node identity to the AE or the CSE. The replacing node identity corresponds to the AE identity or the CSE identity.

In an exemplary embodiment, the resource management module may further be arranged to, when receiving a node resource creation request of requesting a resource for a new application node or a new intermediate node from the AE or the CSE after returning the replacing node identity to the AE or the CSE, create a new node resource for the new application node or the new intermediate node, and find a corresponding AE resource or CSE resource according to the replacing node identity. The node resource creation request includes the replacing node identity, the node identity and the type of the resource to be created.

In an exemplary embodiment, the resource association module is arranged to establish the association relationship between the AE resource which has been created for the AE and the currently created node resource in the following manner:

establishing the association relationship between the AE resource of which the attribute includes the AE identity and the currently created node resource.

In an exemplary embodiment, the resource association module is arranged to establish the association relationship between the CSE resource which has been created for the CSE and the currently created node resource in the following manner:

establishing the association relationship between the CSE resource of which the attribute includes the CSE identity and the currently created node resource is established.

In an exemplary embodiment, the resource association module is arranged to establish the association relationship between the AE resource which has been created for the AE and the currently created node resource in the following manner:

setting a value of a “node connection” attribute of the AE resource to be the node identity or an address of the currently created node resource.

In an exemplary embodiment, the resource association module is arranged to establish the association relationship between the CSE resource and the currently created node resource in the following manner:

setting a value of a “node connection” attribute of the CSE resource to be the node identity or an address of the currently created node resource.

In order to solve the technical problem, an embodiment of the present disclosure further provides a computer storage medium, in which a computer-executable instruction may be stored, the computer-executable instruction being arranged to execute the abovementioned method.

In the technical solutions, the registration CSE creates the node resource for the node where the AE or the CSE is located, and establishes the association relationship between the AE resource and the created node resource, or establishes the association relationship between the CSE resource and the created node resource. By virtue of the technical solution, a purpose of associating the AE resource with the node to which the AE resource belongs and associating the CSE resource with the node to which the CSE resource belongs on the registration CSE can be achieved. In addition, in the technical solutions, when the node where the AE or the CSE is located is replaced, the AE resource or CSE resource stored in the registration CSE is not deleted, and instead, the association relationship between the replacing node and the AE resource or the CSE resource is established, so that the replacing node may continue using the AE resource or CSE resource before node replacement. In this way, the problem of running data loss under the condition that the application node and/or the intermediate node are/is replaced and the replacing nodes/node are/is expected to reserve running data of the replaced nodes/node is solved.

### BRIEF DESCRIPTION OF THE DRAWINGS

FIG. 1 is a structure diagram of an M2M communication network according to the related technology;

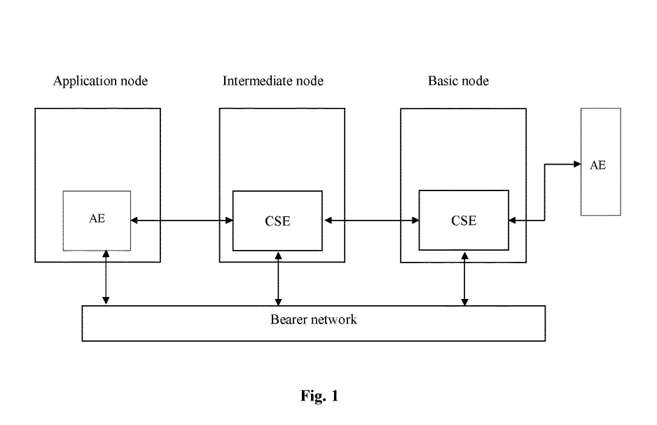

FIG. 2 is a flowchart of a method for managing an application resource according to an embodiment; and

FIG. 3 is a module diagram of a registration node for managing an application resource according to an embodiment.

### DETAILED DESCRIPTION OF THE EMBODIMENTS

The embodiments of the present disclosure will be described below with reference to the drawings in detail. It is important to note that the embodiments in the present disclosure and characteristics in the embodiments may be freely combined under the condition of no conflicts.

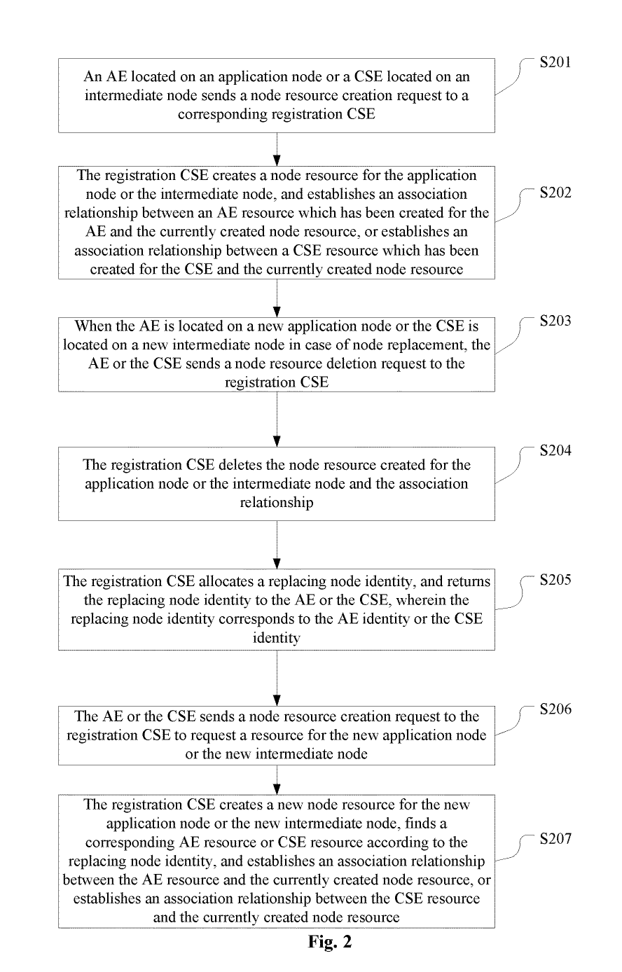

FIG. 2 is a flowchart of a method for managing an application resource according to an embodiment. The method may include the following steps.

In a step of S201, an AE located on an application node or a CSE located on an intermediate node sends a node resource creation request to a corresponding registration CSE to request a resource for the application node where the AE is located or the intermediate node where the CSE is located.

The node resource creation request includes: an AE identity of the AE or a CSE identity of the CSE, a node identity and a type of the resource to be created. The type of the resource to be created may be a node type.

In a step of S202, the registration CSE creates a node resource for the application node or the intermediate node, and establishes an association relationship between an AE resource which has been created for the AE and the currently created node resource, or establishes an association relationship between a CSE resource which has been created for the CSE and the currently created node resource.

An attribute of the AE resource includes the AE identity, and an attribute of the CSE resource includes the CSE identity.

The registration CSE creates a resource of the node type after receiving the resource creation request. A “node identity” attribute may be set for the node resource, and an attribute value of the “node identity” attribute is the node identity carried in the resource creation request.

In an exemplary embodiment, the step that the registration CSE establishes the association relationship between the AE resource and the currently created node resource includes that:

the association relationship between the AE resource of which the attribute includes the AE identity and the currently created node resource is established.

In an exemplary embodiment, the step that the registration CSE establishes the association relationship between the CSE resource and the currently created node resource includes that:

the association relationship between the CSE resource of which the attribute includes the CSE identity and the currently created node resource is established.

In an exemplary embodiment, the step that the registration CSE establishes the association relationship between the AE resource and the currently created node resource includes that:

a value of a “node connection” attribute of the AE resource is set to be the node identity or an address of the currently created node resource.

In an exemplary embodiment, the step that the registration CSE establishes the association relationship between the CSE resource and the currently created node resource includes that:

a value of a “node connection” attribute of the CSE resource is set to be the node identity or an address of the currently created node resource.

In a step of S203, when the AE is located on a new application node or the CSE is located on a new intermediate node in case of node replacement, the AE or the CSE sends a node resource deletion request to the registration CSE.

The node resource deletion request includes: a node replacement indication, the AE or CSE identity and the address of the replaced node resource.

In a step of S204, the registration CSE deletes the node resource created for the application node or the intermediate node and the association relationship.

The registration CSE finds the node resource to be deleted according to the address of the replaced node resource.

In an exemplary embodiment, the step that the registration CSE deletes the established association relationship includes that:

the node connection attribute of the AE or CSE resource is deleted, or, the value of the node connection attribute of the AE or CSE resource is set to be null.

In a step of S205, the registration CSE allocates a replacing node identity, and returns the replacing node identity to the AE or the CSE. The replacing node identity corresponds to the AE identity or the CSE identity.

In a step of S206, the AE or the CSE sends a node resource creation request to the registration CSE to request a resource for the new application node or the new intermediate node.

The node resource creation request includes: the replacing node identity, the node identity and the type of the resource to be created.

In a step of S207, the registration CSE creates a new node resource for the new application node or the new intermediate node, finds a corresponding AE resource or CSE resource according to the replacing node identity, and establishes an association relationship between the AE resource and the currently created node resource, or establishes an association relationship between the CSE resource and the currently created node resource.

In the technical solution, the registration CSE creates the node resource for the node where the AE or the CSE is located, and establishes the association relationship between the AE resource and the created node resource, or establishes the association relationship between the CSE resource and the created node resource. By virtue of the technical solution, a purpose of associating the AE resource with the node to which the AE resource belongs and associating the CSE resource with the node to which the CSE resource belongs on the registration CSE can be achieved. In addition, in the technical solution, when the node where the AE or the CSE is located is replaced, the AE resource or CSE resource stored in the registration CSE is not deleted, and instead, the association relationship between the replacing node and the AE resource or the CSE resource is established, so that the replacing node may continue using the AE resource or CSE resource before node replacement. In this way, the problem of running data loss under the condition that the application node and/or the intermediate node are/is replaced and the replacing nodes/node are/is expected to reserve running data of the replaced nodes/node is solved.

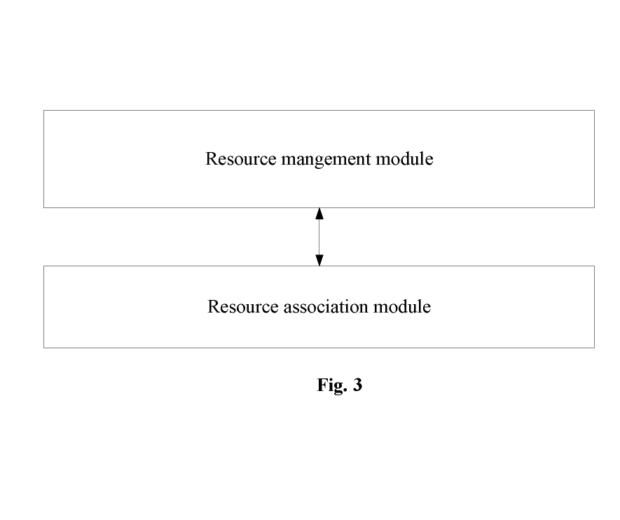

FIG. 3 is a module diagram of a registration node for managing an application resource according to an embodiment.

The registration node includes: a resource management module and a resource association module.

The resource management module is arranged to, after receiving node resource creation request sent by an AE or a CSE, create a node resource for an application node where the AE is located or an intermediate node where the CSE is located.

The node resource creation request includes: an AE identity of the AE or a CSE identity of the CSE, a node identity and a type of the resource to be created. The type of the resource to be created may be a node type.

The resource association module is arranged to establish an association relationship between an AE resource which has been created for the AE and the currently created node resource, or establish an association relationship between a CSE resource which has been created for the CSE and the currently created node resource. An attribute of the AE resource includes the AE identity, and an attribute of the CSE resource includes the CSE identity.

In an exemplary embodiment, the resource association module is arranged to establish the association relationship between the AE resource which has been created for the AE and the currently created node resource in the following manner:

establishing the association relationship between the AE resource of which the attribute includes the AE identity and the currently created node resource.

In an exemplary embodiment, the resource association module is arranged to establish the association relationship between the CSE resource which has been created for the CSE and the currently created node resource in the following manner:

establishing the association relationship between the CSE resource of which the attribute includes the CSE identity and the node resource.

In an exemplary embodiment, the resource association module is arranged to establish the association relationship between the AE resource which has been created for the AE and the currently created node resource in the following manner:

setting a value of a “node connection” attribute of the AE resource to be the node identity or an address of the currently created node resource.

In an exemplary embodiment, the resource association module is arranged to establish the association relationship between the CSE resource and the currently created node resource in the following manner:

setting a value of a “node connection” attribute of the CSE resource to be the node identity or an address of the currently created node resource.

The resource management module is further arranged to, when receiving a node resource deletion request from the AE or the CSE after receiving the node resource creation request sent by the AE or the CSE, delete the node resource created for the application node or the intermediate node and the association relationship. The node resource deletion request includes a node replacement indication, the AE identity or the CSE identity.

In an exemplary embodiment, the resource management module is arranged to delete association relationship in the following manner:

deleting the node connection attribute of the AE or CSE resource, or, setting a value of the node connection attribute of the AE or CSE resource to be null.

The resource management module, besides being arranged to delete the node resource created for the application node or the intermediate node and the association relationship, is further arranged to allocate a replacing node identity to the AE or the CSE, and return the replacing node identity to the AE or the CSE. The replacing node identity corresponds to the AE identity or the CSE identity.

The resource management module is further arranged to, when receiving a node resource creation request of requesting a resource for a new application node or a new intermediate node from the AE or the CSE after returning the replacing node identity to the AE or the CSE, create a new node resource for the new application node or the new intermediate node, and find a corresponding AE resource or CSE resource according to the replacing node identity.

The node resource creation request of requesting the resource for the new application node or the new intermediate node includes: the AE identity or the CSE identity, the node identity and the type of the resource to be created.

In the technical solution, the registration CSE creates the node resource for the node where the AE or the CSE is located, and establishes the association relationship between the AE resource and the created node resource, or establishes the association relationship between the CSE resource and the created node resource. By virtue of the technical solution, a purpose of associating the AE resource with the node to which the AE resource belongs and associating the CSE resource with the node to which the CSE resource belongs on the registration CSE can be achieved. In addition, in the technical solution, when the node where the AE or the CSE is located is replaced, the AE resource or CSE resource stored in the registration CSE is not deleted, and instead, the association relationship between the replacing node and the AE resource or the CSE resource is established, so that the replacing node may continue using the AE resource or CSE resource before node replacement. In this way, the problem of running data loss under the condition that the application node and/or the intermediate node are/is replaced and the replacing nodes/node are/is expected to reserve running data of the replaced nodes/node is solved.

Those skilled in the art should know that all or part of the steps in the method may be implemented by related hardware instructed by a program, and the program may be stored in a computer-readable storage medium, such as a read-only memory, a magnetic disk or an optical disk. Alternatively, all or part of the steps of the embodiments may also be implemented by virtue of one or more integrated circuits, and correspondingly, each module/unit in the embodiments may be implemented by adopting a hardware form, and may also be implemented by adopting a software function module form. The present disclosure is not limited to a hardware and software combination in any specific form.

It is important to note that the prevent disclosure may have many other embodiments, those skilled in the art may make various corresponding variations and transformations to the present disclosure without departing from the essence of the present disclosure, but these corresponding variations and transformations shall fall within the scope of protection of the appended claims of the present disclosure.

### INDUSTRIAL APPLICABILITY

In the above technical solutions, the purpose of associating the AE resource with the node to which the AE resource belongs and associating the CSE resource with the node to which the CSE resource belongs on the registration CSE is achieved. In addition, in the technical solutions, when the node where the AE or the CSE is located is replaced, the AE resource or CSE resource stored in the registration CSE is not deleted, and instead, the association relationship between the replacing node and the AE resource or the CSE resource is established, so that the replacing node may continue using the AE resource or CSE resource before node replacement. In this way, the problem of running data loss under the condition that the application node and/or the intermediate node are/is replaced and the replacing nodes/node are/is expected to reserve running data of the replaced nodes/node is solved.

1. A method for managing an application resource, comprising:
sending, by an Application Entity (AE) or a Common Service Entity (CSE), a node resource creation request to a registration CSE of the AE or CSE to request a resource for an application node where the AE is located or an intermediate node where the CSE is located, wherein the node resource creation request comprises an AE identity of the AE or a CSE identity of the CSE, a node identity and a type of the resource to be created; and
creating, by the registration CSE, a node resource for the application node or the intermediate node, and establishing, by the registration CSE, an association relationship between an AE resource which has been created for the AE and the currently created node resource, or establishing, by the registration CSE, an association relationship between a CSE resource which has been created for the CSE and the currently created node resource, wherein an attribute of the AE resource comprises the AE identity and an attribute of the CSE resource comprises the CSE identity.

2. The method as claimed in claim 1, further comprising:
after sending, by the AE or the CSE, the node resource creation request to the registration CSE to request the resource for the application node or the intermediate node, when the AE is located on a new application node or the CSE is located on a new intermediate node in case of node replacement, sending, by the AE or the CSE, a node resource deletion request to the registration CSE; and
deleting, by the registration CSE, the node resource created for the application node or the intermediate node and the association relationship.

3. The method as claimed in claim 2, wherein
the node resource deletion request comprises a node replacement indication, the AE identity or the CSE identity; and
the method further comprises:
besides deleting the node resource created for the application node or the intermediate node and the association relationship, further allocating, by the registration CSE, a replacing node identity to the AE or the CSE, and returning, by the registration CSE, the replacing node identity to the AE or the CSE, wherein the replacing node identity corresponds to the AE identity or the CSE identity.

4. The method as claimed in claim 3, further comprising:
after returning, by the registration CSE, the replacing node identity to the AE or the CSE, sending, by the AE or the CSE, a node resource creation request to the registration CSE to request a resource for the new application node or the new intermediate node, wherein the node resource creation request comprises the replacing node identity, the node identity and the type of the resource to be created; and
creating, by the registration CSE, a new node resource for the new application node or the new intermediate node, finding, by the registration CSE, a corresponding AE resource or CSE resource according to the replacing node identity, and establishing, by the registration CSE, an association relationship between the AE resource and the currently created node resource, or establishing, by the registration CSE, an association relationship between the CSE resource and the currently created node resource.

5. The method as claimed in claim 1, wherein establishing the association relationship between the AE resource and the currently created node resource comprises:
establishing the association relationship between the AE resource of which the attribute comprises the AE identity and the currently created node resource; and
establishing the association relationship between the CSE resource and the currently created node resource comprises:
establishing the association relationship between the CSE resource of which the attribute comprises the CSE identity and the currently created node resource.

6. The method as claimed in claim 5, wherein
establishing the association relationship between the AE resource and the currently created node resource comprises:
setting a value of a “node connection” attribute of the AE resource to be the node identity or an address of the currently created node resource; and
establishing the association relationship between the CSE resource and the currently created node resource comprises:
setting a value of a “node connection” attribute of the CSE resource to be the node identity or an address of the currently created node resource.

7. A registration node for managing an application resource, comprising a hardware processor arranged to execute the following program modules: a resource management module and a resource association module, wherein
the resource management module is arranged to, after receiving a node resource creation request sent by an Application Entity (AE) or a Common Service Entity (CSE), create a node resource for an application node where the AE is located or an intermediate node where the CSE is located, wherein the node resource creation request comprises an AE identity of the AE or a CSE identity of the CSE, a node identity and a type of the resource to be created; and
the resource association module is arranged to establish an association relationship between an AE resource which has been created for the AE and the currently created node resource, or establish an association relationship between a CSE resource which has been created for the CSE and the currently created node resource, wherein an attribute of the AE resource comprises the AE identity and an attribute of the CSE resource comprises the CSE identity.

8. The registration node as claimed in claim 7, wherein
the resource management module is further arranged to, when receiving a node resource deletion request from the AE or the CSE after receiving the node resource creation request sent by the AE or the CSE, delete the node resource created for the application node or the intermediate node and the association relationship.

9. The registration node as claimed in claim 8, wherein
the node resource deletion request comprises a node replacement indication, the AE identity or the CSE identity; and
the resource management module is further arranged to allocate a replacing node identity to the AE or the CSE, and return the replacing node identity to the AE or the CSE, wherein the replacing node identity corresponds to the AE identity or the CSE identity.

10. The registration node as claimed in claim 9, wherein
the resource management module is further arranged to, when receiving a node resource creation request of requesting a resource for a new application node or a new intermediate node from the AE or the CSE after returning the replacing node identity to the AE or the CSE, create a new node resource for the new application node or the new intermediate node, and find a corresponding AE resource or CSE resource according to the replacing node identity, wherein the node resource creation request comprises the replacing node identity, the node identity and the type of the resource to be created.

11. The registration node as claimed in claim 7, wherein
the resource association module is arranged to establish the association relationship between the AE resource which has been created for the AE and the currently created node resource in the following manner:
establishing the association relationship between the AE resource of which the attribute comprises the AE identity and the currently created node resource; and
the resource association module is arranged to establish the association relationship between the CSE resource which has been created for the CSE and the currently created node resource in the following manner:
establishing the association relationship between the CSE resource of which the attribute comprises the CSE identity and the currently created node resource.

12. The registration node as claimed in claim 11, wherein
the resource association module is arranged to establish the association relationship between the AE resource which has been created for the AE and the currently created node resource in the following manner:
setting a value of a “node connection” attribute of the AE resource to be the node identity or an address of the currently created node resource; and
the resource association module is arranged to establish the association relationship between the CSE resource and the currently created node resource in the following manner:
setting a value of a “node connection” attribute of the CSE resource to be the node identity or an address of the currently created node resource.

13. A computer storage medium, in which a computer-executable instruction is stored, the computer-executable instruction being arranged to execute the method as claimed in claim 1.

14. The method as claimed in claim 2, wherein
establishing the association relationship between the AE resource and the currently created node resource comprises:
establishing the association relationship between the AE resource of which the attribute comprises the AE identity and the currently created node resource; and
establishing the association relationship between the CSE resource and the currently created node resource comprises:
establishing the association relationship between the CSE resource of which the attribute comprises the CSE identity and the currently created node resource.

15. The method as claimed in claim 3, wherein
establishing the association relationship between the AE resource and the currently created node resource comprises:
establishing the association relationship between the AE resource of which the attribute comprises the AE identity and the currently created node resource; and
establishing the association relationship between the CSE resource and the currently created node resource comprises:
establishing the association relationship between the CSE resource of which the attribute comprises the CSE identity and the currently created node resource.

16. The method as claimed in claim 4, wherein
establishing the association relationship between the AE resource and the currently created node resource comprises:
establishing the association relationship between the AE resource of which the attribute comprises the AE identity and the currently created node resource; and
establishing the association relationship between the CSE resource and the currently created node resource comprises:
establishing the association relationship between the CSE resource of which the attribute comprises the CSE identity and the currently created node resource.

17. The method as claimed in claim 2, wherein deleting, by the registration CSE, the association relationship comprises:
deleting a “node connection” attribute of the AE resource or the CSE resource, or, setting a value of the “node connection” attribute of the AE resource or the CSE resource to be null.

18. The registration node as claimed in claim 8, wherein
the resource association module is arranged to establish the association relationship between the AE resource which has been created for the AE and the currently created node resource in the following manner:
establishing the association relationship between the AE resource of which the attribute comprises the AE identity and the currently created node resource; and
the resource association module is arranged to establish the association relationship between the CSE resource which has been created for the CSE and the currently created node resource in the following manner:
establishing the association relationship between the CSE resource of which the attribute comprises the CSE identity and the currently created node resource.

19. The registration node as claimed in claim 9, wherein
the resource association module is arranged to establish the association relationship between the AE resource which has been created for the AE and the currently created node resource in the following manner:
establishing the association relationship between the AE resource of which the attribute comprises the AE identity and the currently created node resource; and
the resource association module is arranged to establish the association relationship between the CSE resource which has been created for the CSE and the currently created node resource in the following manner:
establishing the association relationship between the CSE resource of which the attribute comprises the CSE identity and the currently created node resource.

20. The registration node as claimed in claim 8, wherein the resource management module is arranged to delete the association relationship in the following manner:
deleting a “node connection” attribute of the AE resource or the CSE resource, or, setting a value of the “node connection” attribute of the AE resource or the CSE resource to be null.
